(19) United States
(12) Patent Application Publication
(10) Pub. No.: US 2024/0301919 A1
(43) Pub. Date: Sep. 12, 2024

(54) Drive System for Sidewind Trailer Jacks

(71) Applicant: Kenneth David Little, Orlando, FL (US)

(72) Inventor: Kenneth David Little, Orlando, FL (US)

(21) Appl. No.: 18/182,315

(22) Filed: Mar. 10, 2023

(51) Int. Cl. F16D 1/108; B66D 1/14

(52) U.S. Cl. CPC F16D 1/108; B66D 1/14; B60D 1/66; B60P 7/0846; B60S 9/04

(57) ABSTRACT

The Drive System consists of a Dual-Purpose Driver (100) and an Adapter 200, allowing a battery powered drill to drive either a Sidewind Dropleg Trailer Jack or a Strap Winch. The Dual-Purpose Driver (100) inserts into a Strap Winch or into the Adapter 200 which replaces the handle of a Sidewind Dropleg Trailer Jack. The hex rod (10) inserts into the battery powered drill. Spring loaded buttons (50) protruding from the hollow cylinder (20) of the Dual-Purpose Driver 100 engage the Strap Winch, while slots (40) slide over a pin 140 in the Adapter 200.

### BACKGROUND OF THE INVENTION

The invention relates to raising and lowering the front of trailers having Sidewind Dropleg Trailer Jacks, and strapping cargo to flatbed trailers.

When not attached to a truck, the front end of a trailer is supported by a Sidewind Dropleg Trailer Jack, as shown in FIG. 1. In the example in FIG. 1a, there are two jacks, thus the configuration is called a Dual Sidewind Dropleg Trailer Jack. In the example of FIG. 1b, there is one jack, thus the configuration is called a Single Sidewind Dropleg Trailer Jack.

To raise or lower the trailer, the jack handle is lifted out of its support clips, engaged in the drive slot, and rotated manually. There are 1^{st} and 2^{nd} gears in each jack to make the task easier, but it is an arduous task whenever the trailer and truck are coupled or decoupled, because of the large force and high number of rotations required to achieve the tasks.

Cargo is anchored to a flatbed trailer using multiple straps, each of which is wound around the shaft of a Shaft Winch, typically configured as shown in FIG. 4. The strap is wound around the shaft by engaging the drive holes on the right. This can be done manually, or with a strap winder device.

### BRIEF SUMMARY OF THE INVENTION

The invention is a drive system which allows a Sidewind Dropleg Trailer Jack to be driven using a battery powered drill instead of manually. A part in the drive system can be used on its own with the battery powered drill to rotate the shaft winch.

### BRIEF DESCRIPTION OF THE SEVERAL VIEWS OF THE DRAWINGS

The invention is explained in the following description in view of the drawings that show:

FIG. 1a is a view of a typical Dual Sidewind Dropleg Trailer Jack

FIG. 1b is a view of a typical Single Sidewind Dropleg Trailer Jack

FIG. 2 is an isometric view of a Strap Winch

FIG. 3 contains both a cross section and an oblique view of the Drive System's Adapter

FIG. 4 is an isometric view of the Drive System's Dual-Purpose Driver.

### DETAILED DESCRIPTION OF THE INVENTION

The inventor has created a Drive System which eliminates the manually intensive efforts of jacking the front end of a trailer, and rewinding the straps which secure the cargo on a flatbed trailer. The Drive System, consisting of an Adapter and a Dual-Purpose Driver, allows a battery powered drill to rotate a Sidewind Dropleg Trailer Jack drive shaft. Additionally, the Dual-Purpose Driver may be used without the Adaptor to rotate a Strap Winch.

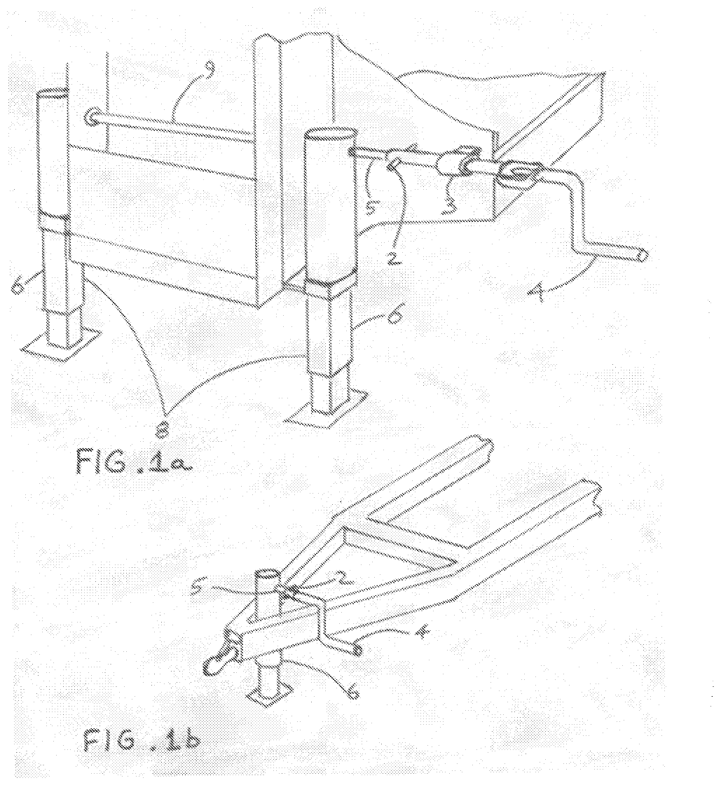

A Dual Sidewind Dropleg Trailer Jack 8 is shown in FIG. 1a, and a Single Sidewind Dropleg Trailer Jack 6 is shown in FIG. 1b. Each Sidewind Dropleg Trailer Jack is driven by a handle 4. The two individual jacks 6 in the Dual Sidewind Dropleg Trailer Jack are connected by shaft 9. Handle 4 is manually rotated to drive gears in each jack which move legs up or down. The handle mechanism is supported by sleeve 3 in a Dual Sidewind Dropleg Trailer Jack configuration 8 and is attached to the Sidewind Dropleg Trailer Jack drive shaft 5 by bolt 2. In FIG. 1b it is seen that sleeve 3 is not required as handle mechanism is attached directly to the Single Sidewind Dropleg Trailer Jack drive shaft 5 by bolt 2.

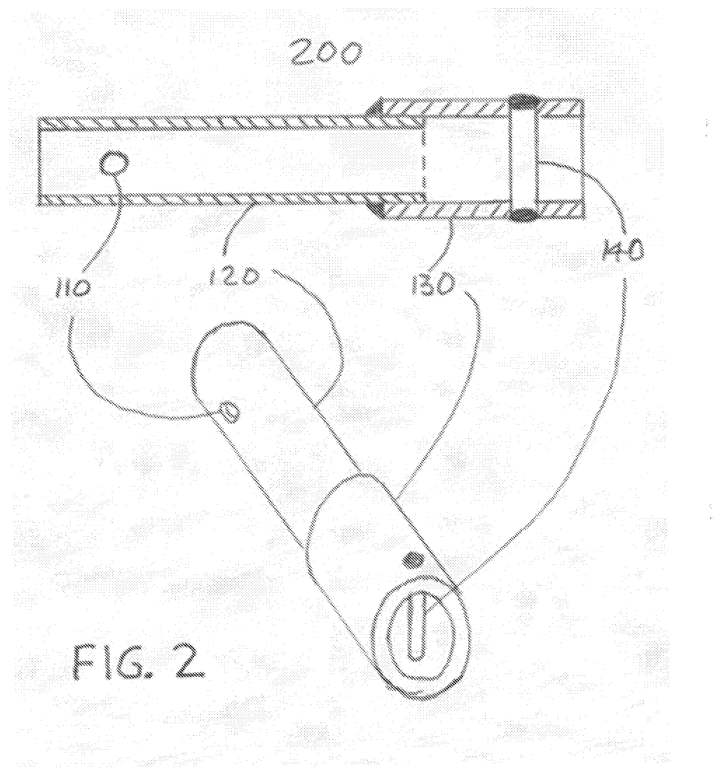

To convert the Dual Sidewind Dropleg Trailer Jack 8 manual drive system shown in FIG. 1a to a battery powered drill Drive System, bolt 2 is removed and the handle mechanism retracted through support sleeve 3. The small diameter pipe 120 of the Adapter 200 shown in FIG. 2, is inserted through sleeve 3, slid over the drive shaft 5, and bolt 2 is reinstalled through drive hole 110 of the Adapter 200 and the corresponding hole in the Dual Sidewind Dropleg Trailer Jack drive shaft 5.

To convert the Single Sidewind Dropleg Trailer Jack 6 manual drive system shown in FIG. 1b to a battery powered drill Drive System, bolt 2 and the handle mechanism are removed. The small diameter pipe 120 of the Adapter shown in FIG. 2, is slid over the drive shaft 5, and bolt 2 is reinstalled through drive hole 110 of the Adapter 200 and the corresponding hole in the Single Sidewind Dropleg Trailer Jack drive shaft 5.

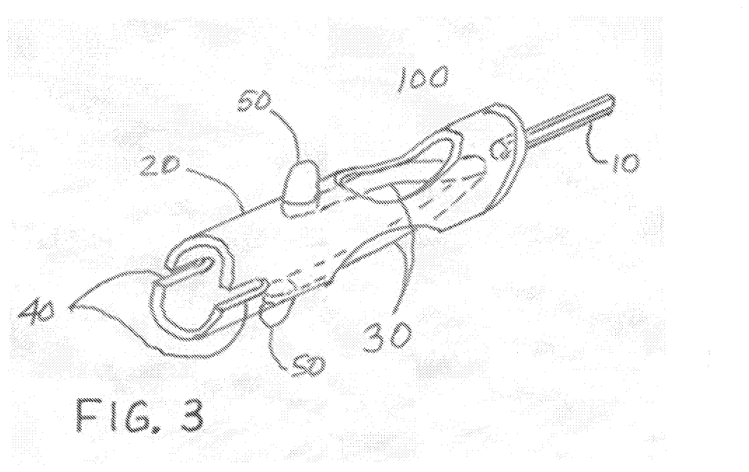

To drive either the Dual or Single Sidewind Dropleg Trailer Jacks, the hex shaft 10 of the Dual-Purpose Driver 100 shown in FIG. 3 is inserted into a battery powered drill and the hollow cylinder 20 of the Dual-Purpose Driver 100 is inserted into the Adapter 200 shown in FIG. 2 such that the slots 40 in the Dual-Purpose Driver 100 fully engage the pin 140 of the Adapter 200. Raising or lowering the trailer is accomplished by changing the rotation direction of the battery powered drill.

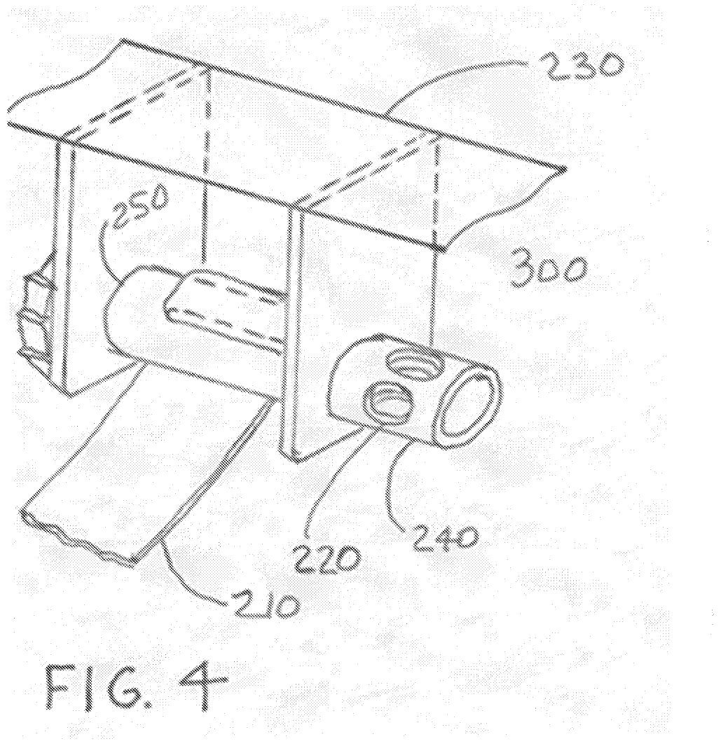

The second purpose of the Dual-Purpose Driver 100 shown in FIG. 3 is to rewind strap 210 into the Strap Winch 300 installed in a trailer rail 230, shown in FIG. 4. The Dual-Purpose Driver 100's hollow cylinder 20 is inserted into the drive end 240 of the Strap Winch 300's shaft 250. Buttons 50 of the Double Button Spring Clip 30 are retracted into the hollow cylinder 20 by pressing together the Double Button Spring Clip 30 until the buttons allow the Dual-Purpose Driver 100 to slide into the drive end 240, then are released, allowing the buttons to engage 2 of the 4 holes 220 in the drive end 240. Rotating the Dual-Purpose Driver 100 then rotates shaft 250 of the Strap Winch 300 and winds strap 210 onto the shaft 250. When the strap is fully rewound, the buttons are retracted into cylinder 210 by pressing together the Double Button Spring Clip 30 allowing withdrawal of the Dual-Purpose Driver 100 from the Strap Winch 300.

From the foregoing it is evident that the inventor has developed a Drive System, which when driven by a battery powered drill eliminates the intensive manual labor associated with jacking a trailer. The Drive System is simple, effective and practical. In addition, the Dual-Purpose Driver of the Drive System can be used alone to provide for the rotation of Strap Winches associated with flatbed trailers.

While a single embodiment of the present invention has been shown and described within, numerous variations, changes and substitutions may be made without departing from the intent of the invention. Accordingly, it is intended that the invention be limited only by the spirit and scope of the appended claims.

The invention claimed is:

1. A Sidewind Dropleg Trailer Jack Drive System, comprising:
an Adapter and,
a Dual-Purpose Driver.

2. A Sidewind Dropleg Trailer Jack Drive System which connects a battery powered drill and a Sidewind Dropleg Trailer Jack when the Dual-Purpose Driver and Adapter are coupled.

3. In the arrangement of claim 2, the Adapter connects the Sidewind Dropleg Trailer Jack and the Dual-Purpose Driver by using:
a smaller diameter pipe to connect to a Sidewind Dropleg Trailer Jack drive shaft, and
a larger diameter pipe incorporating a pin to engage the Dual-Purpose Driver.

4. In the arrangement of claim 2, the Dual-Purpose Driver connects the Adapter to the battery powered drill using:
slots in the Dual-Purpose Driver to engage a pin in the Adapter, and
the hex shaft in the Dual-Purpose Driver to insert into a battery powered drill.

5. In the arrangement of claim 2, the driver can be any electric or pneumatic powered drill or device which can attach to the hex shaft of the Dual-Purpose Driver.

6. The Drive System can be used to drive any type of trailer which has a Dual or Single Sidewind Dropleg Trailer Jack.

7. When there are Strap Winches (on a flatbed trailer), the Dual-Purpose Driver of the Drive System can be used to drive the Strap Winches.

8. In the arrangement of claim 7, the buttons of the Dual Button Spring Clip are inserted into the Strap Winch drive holes.

9. In the arrangement of claim 7, the Dual Button Spring Clip can be replaced with any type of spring loaded buttons.
